(19) United States
(12) Patent Application Publication
(10) Pub. No.: US 2008/0297856 A1
(43) Pub. Date: Dec. 4, 2008

(54) Image forming apparatus and image scanning device

(76) Inventor: Kenya Orita, Fujisawa-shi (JP)

Correspondence Address: HARNESS, DICKEY & PIERCE, P.L.C., P.O. BOX 8910, RESTON, VA, 20195, US

(21) Appl. No.: 12/155,369

(22) Filed: Jun. 3, 2008

(30) Foreign Application Priority Data
Jun. 4, 2007 (JP) 2007-148556

(51) Int. Cl. H04N 1/04

(52) U.S. Cl. 358/496

(57) ABSTRACT

An image forming apparatus includes an image forming device and an image scanning device. The image forming device forms an image on a recording medium on the basis of image information of an image scanning target scanned by the image scanning device including a conveyance device and a plurality of image sensors. The conveyance device includes a movable surface which moves to convey the scanning target in contact therewith to have the scanning target pass through a predetermined image scanning position. The image sensors are arranged in a perpendicular direction to a conveyance direction of the scanning target and at positions facing the conveyance device across the predetermined image scanning position to scan the scanning target and obtain the image information. Adjacent two of the image sensors have mutually overlapping scanning areas in the perpendicular direction, and have mutually different positions in the conveyance direction.

### CROSS-REFERENCE TO RELATED APPLICATION

This application claims priority to Japanese Patent Application No. 2007-148556 filed on Jun. 4, 2007 in the Japan Patent Office, the entire contents of which are hereby incorporated by reference herein.

### BACKGROUND OF THE INVENTION

1. Field of the Invention

The present invention relates to an image forming apparatus such as a copier, a printer, and a facsimile machine, and an image scanning device installed in the image forming apparatus.

2. Discussion of the Background Art

A known image scanning device like that illustrated in FIG. 1A includes, as a scanning unit, a single image sensor 101 for covering the whole area of a sheet S in a direction perpendicular to a direction in which the sheet S is conveyed (hereinafter referred to as the sheet width direction). Although such image scanning device can easily obtain high-quality image information, it has a disadvantage in that the device requires a relatively large sensor having a size sufficient for covering the whole area of the sheet S in the sheet width direction, and thus increases component costs.

As an image scanning device capable of overcoming such a disadvantage, an image scanning device like that illustrated in FIG. 1B is known which includes a plurality of image sensors 201 arranged in a zigzag pattern along the sheet width direction to reduce the size of each of the image sensors 201, and thus reduce component costs.

FIG. 2 is an explanatory diagram illustrating a configuration of the image scanning device illustrated in FIGS. 1A and 1B in a vicinity of an image scanning position thereof.

The image scanning device includes first conveyance rollers 500, a plurality of image sensors including two first image sensors 900 and a single second image sensor 110, a retainer plate 13, and second conveyance rollers 700. The first conveyance rollers 500 convey the sheet S toward a contact glass 300. The two first image sensors 900 and the second image sensor 110 are arranged in the zigzag pattern to scan the sheet S passing over the contact glass 300 to obtain the image information of the sheet S. The retainer plate 13 presses the sheet S against the contact glass 300. The second conveyance rollers 700 discharge the sheet S having passed the contact glass 300. The two first image sensors 900 are located upstream of the second image sensor 110 in the sheet conveyance direction, and are disposed on opposite sides of the contact glass 300 in the sheet width direction. Meanwhile, the second image sensor 110 is located downstream of the two first image sensors 900 in the sheet conveyance direction, and is disposed at the center of the contact glass 300 in the sheet width direction, such that the scanning area of the second image sensor 110 overlaps with the scanning areas of the two first image sensors 900 in the sheet width direction. With this configuration, when the sheet S passes over the contact glass 300, the first image sensors 900 and the second image sensor 110 scan the sheet S to obtain the image information thereof.

In general, a general-purpose image sensor has a shallow focal depth. Thus, it is desirable to configure the image scanning device such that the sheet S is made as close to a surface of the contact glass 300 as possible when the sheet S passes over the contact glass 300. In the background image scanning device described above, therefore, the retainer plate 13 is provided in such a way as to provide a minimum clearance necessary for the passage of the sheet S on the contact glass 300, thereby guiding the sheet S passing over the contact glass 300 so that the sheet S can pass over the surface of the contact glass 300.

However, if the sheet S includes a folded or curled portion in the sheet width direction, a relatively large frictional force is generated between the sheet S and the retainer plate 13 when that portion passes through the clearance. As a result, a relatively large difference in frictional force arises in the sheet width direction of the sheet S passing through the clearance, and thus a difference in conveyance speed arises in the sheet width direction. Consequently, there is a relatively high possibility of a deviation in the sheet conveyance direction occurring between the respective image information sets obtained from the scanning by the first image sensors 900 and the second image sensor 110.

### SUMMARY OF THE INVENTION

This patent specification describes an image forming apparatus. In one example, an image forming apparatus includes an image forming device and an image scanning device. The image forming device forms an image on a recording medium on the basis of image information of an image scanning target. The image scanning device scans the image scanning target to obtain the image information. The image scanning device includes a conveyance device and a plurality of image sensors. The conveyance device includes a movable surface which moves to convey the image scanning target in contact therewith to have the image scanning target pass through a predetermined image scanning position. The plurality of image sensors are arranged in a perpendicular direction to a conveyance direction of the image scanning target and at positions facing the predetermined image scanning position and facing the conveyance device across the predetermined image scanning position to scan the image scanning target passing through the predetermined image scanning position and obtain the image information. Adjacent two of the plurality of image sensors have mutually overlapping scanning areas in the perpendicular direction, and have mutually different positions in the conveyance direction.

This patent specification further describes another image forming apparatus. In one example, another image forming apparatus includes image forming means and image scanning means. The image forming means forms an image on a recording medium on the basis of image information of an image scanning target. The image scanning means scans the image scanning target to obtain the image information. The image scanning means includes conveyance means and a plurality of image sensing means. The conveyance means includes a movable surface which moves to convey the image scanning target in contact therewith to have the image scanning target pass through a predetermined image scanning position. The plurality of image sensing means are arranged in a perpendicular direction to a conveyance direction of the image scanning target and at positions facing the predetermined image scanning position and facing the conveyance device across the predetermined image scanning position to scan the image scanning target passing through the predetermined image scanning position and obtain the image information. Adjacent two of the plurality of image sensing means have mutually overlapping scanning areas in the perpendicular direction, and have mutually different positions in the conveyance direction.

This patent specification further describes an image scanning device. In one example, an image scanning device includes a conveyance device and a plurality of image sensors. The conveyance device includes a movable surface which moves to convey an image scanning target in contact therewith to have the image scanning target pass through a predetermined image scanning position. The plurality of image sensors are arranged in a perpendicular direction to a conveyance direction of the image scanning target and at positions facing the predetermined image scanning position and facing the conveyance device across the predetermined image scanning position to scan the image scanning target passing through the predetermined image scanning position and obtain the image information. Adjacent two of the plurality of image sensors have mutually overlapping scanning areas in the perpendicular direction, and have mutually different positions in the conveyance direction.

### BRIEF DESCRIPTION OF THE DRAWINGS

A more complete appreciation of the invention and many of the advantages thereof are obtained as the same becomes better understood by reference to the following detailed description when considered in connection with the accompanying drawings, wherein:

FIG. 1A is an explanatory diagram illustrating a background image sensor having a length covering the whole width of a sheet;

FIG. 1B is an explanatory diagram illustrating image sensors arranged in a zigzag pattern in a sheet width direction of the sheet;

FIG. 2 is an explanatory diagram illustrating a configuration of the surroundings of an image scanning position of a background image scanning device;

FIG. 3 is an explanatory diagram illustrating a schematic configuration of a copier according to an embodiment of the present invention;

FIG. 4 is a partial enlarged view illustrating a schematic configuration of an image scanning device installed in the copier;

FIG. 5 is a top view of image sensors of the image scanning device, as viewed from the side of a contact glass;

FIG. 6 is a top view of a base portion for holding the image sensors;

FIG. 7 is a perspective view of connection members for connecting the image sensors together;

FIGS. 8A and 8B are control block diagrams of a control unit of the image scanning device for performing image processing;

FIGS. 9a and 9B are explanatory diagrams illustrating an operation by the image scanning device of scanning a sheet; and

FIG. 10 is an explanatory diagram illustrating a configuration of the surroundings of a belt conveyance mechanism of the image scanning device.

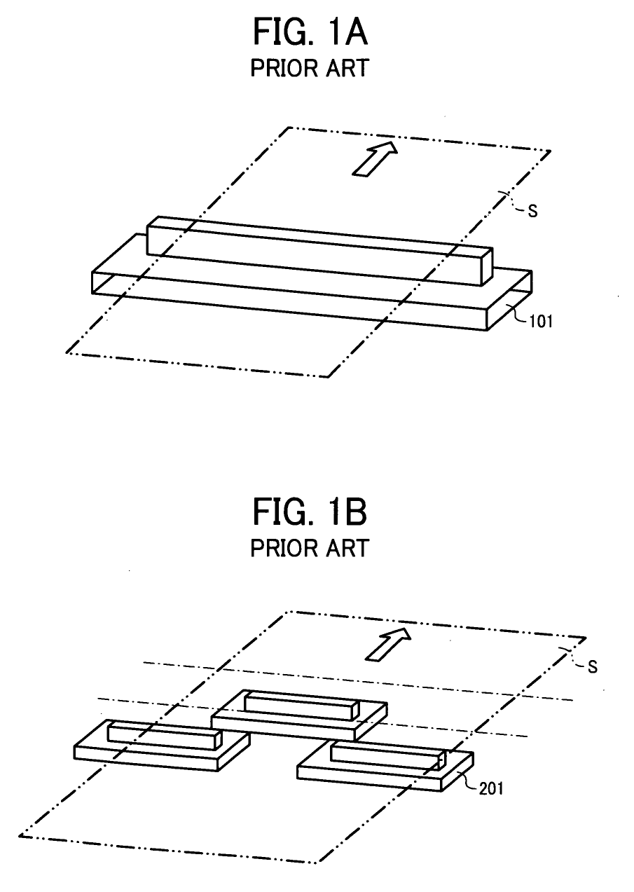

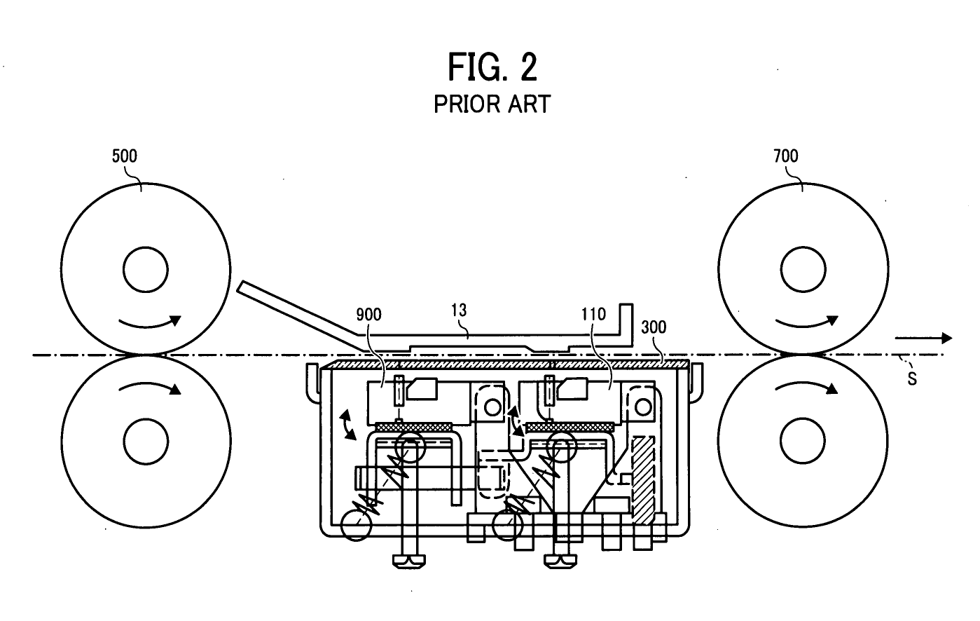

### DETAILED DESCRIPTION OF THE INVENTION

In describing the embodiments illustrated in the drawings, specific terminology is employed for the purpose of clarity. However, the disclosure of this patent specification is not intended to be limited to the specific terminology so used, and it is to be understood that substitutions for each specific element can include any technical equivalents that operate in a similar manner.

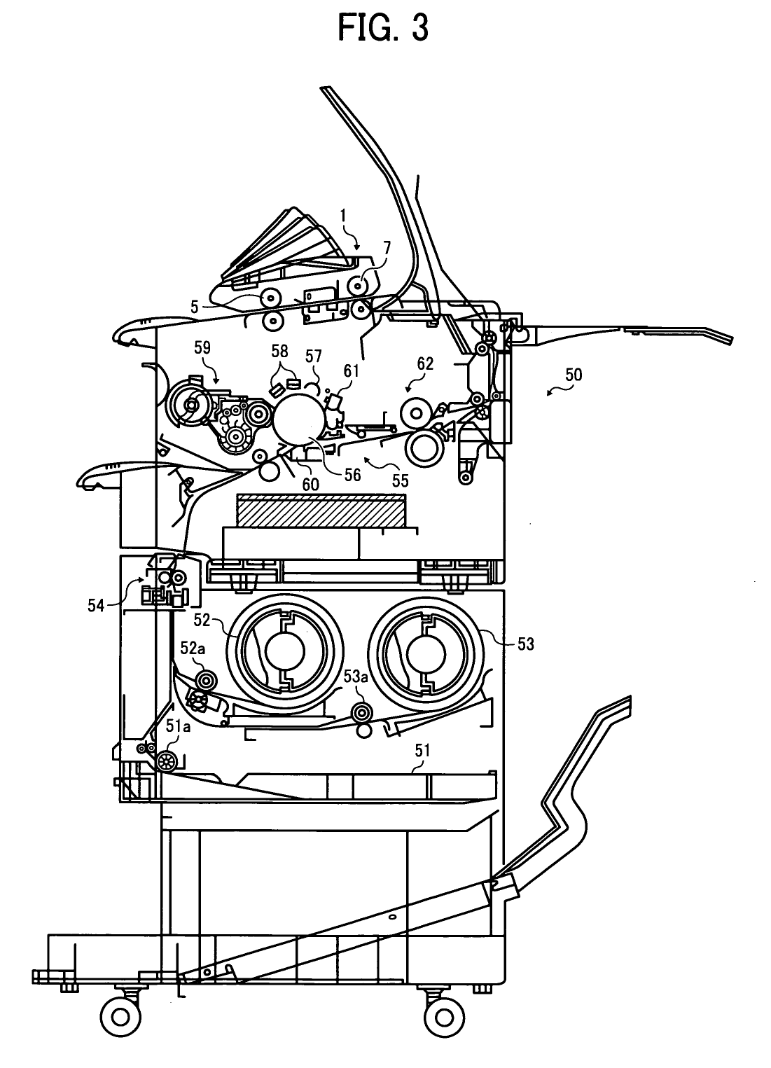

Referring now to the drawings, wherein like reference numerals designate identical or corresponding parts throughout the several views, particularly to FIG. 3, description will now be made of embodiments of the present invention.

FIGS. 3 to 10 are diagrams illustrating an image scanning device according to an embodiment of the present invention and an embodiment of an image forming apparatus installed with the image scanning device. A copier is herein taken as an example of the image forming apparatus. The image forming apparatus, however, is not limited to the copier. Thus, a printer or a facsimile machine, for example, may similarly constitute the image forming apparatus.

FIG. 3 is an explanatory diagram illustrating an overall configuration of a copier 50 according to the present embodiment. The copier 50 includes an image scanning device 1, an image forming device 55, sheet-feeding cassettes 51, 52, and 53, sheet-feeding rollers 51a, 52a, and 53a, and conveyance rollers 54.

The image scanning device 1 is installed in an upper part of the copier 50. The sheet-feeding cassettes 51, 52, and 53 are provided in a lower part of the copier 50. The sheet-feeding cassette 51 stores a sheet-type recording medium as the recording material, while each of the sheet-feeding cassettes 52 and 53 stores a roll-type recording medium. The recording medium stored in each of the sheet-feeding cassettes 51, 52, and 53 is fed by the corresponding one of the sheet-feeding rollers 51a, 52a, and 53a, and then is conveyed by the conveyance rollers 54 to the image forming device 55 located at the upper position.

The image forming device 55 includes a photoconductor drum 56, a charging unit 57, an exposure unit 58, a development unit 59, a transfer unit 60, a cleaning unit 61, and a fixing unit 62. The photoconductor drum 56 functions as an image carrying member. The charging unit 57 functions as a charging device for uniformly charging a surface of the photoconductor drum 56. The exposure unit 58 functions as a latent image forming device for forming an electrostatic latent image on the photoconductor drum 56 on the basis of image information obtained from the scanning by the image scanning device 1. The development unit 59 functions as a development device for developing the electrostatic latent image formed on the photoconductor drum 56 into a visible image by adhering toner to the electrostatic latent image. The transfer unit 60 functions as a transfer device for transferring the toner image formed on the photoconductor drum 56 onto the recording medium. The cleaning unit 61 functions as a cleaning device for removing the toner remaining on the photoconductor drum 56 after the transfer process. The fixing unit 62 functions as a fixing device for fixing the toner image on the recording medium.

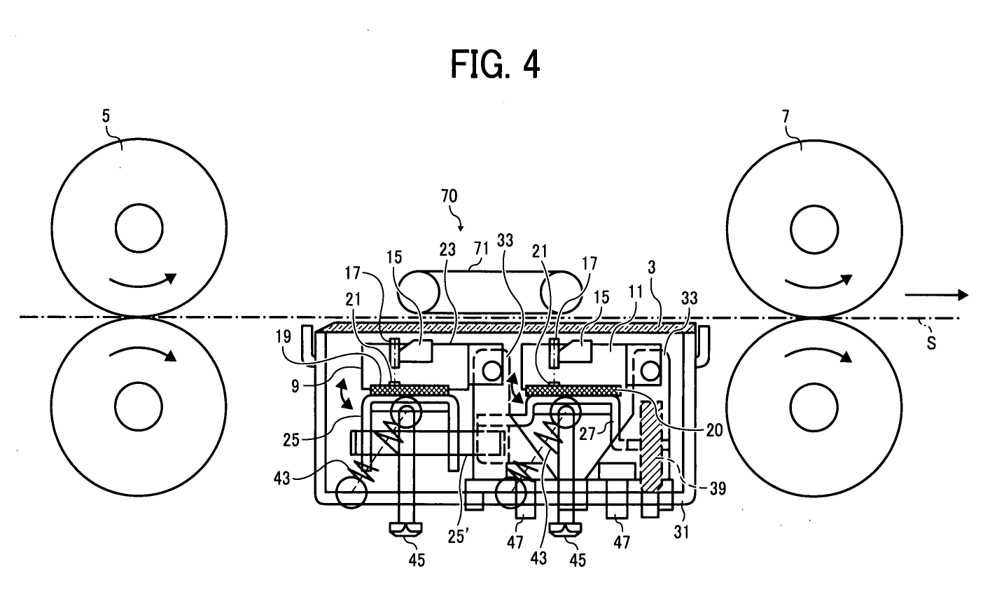

As illustrated in FIG. 4, the image scanning device 1 includes first conveyance rollers 5, a plurality of image sensors including two first image sensors 9 and a second image sensor 11, second conveyance rollers 7, and a belt conveyance mechanism 70. The first conveyance rollers 5 constitute a conveyance device for conveying a sheet S, which is an image scanning target inserted into the image scanning device 1 through an insertion opening, to a contact glass 3 which is a transparent member. The two first image sensors 9 and the second image sensor 11 scan the sheet S passing over the contact glass 3 to obtain the image of the sheet S. The second conveyance rollers 7 constitute a conveyance device for discharging the sheet S subjected to the scanning process in the opposite direction to the insertion opening. The belt conveyance mechanism 70 is provided at a position facing the two first image sensors 9 and the second image sensor 11 across the contact glass 3. The belt conveyance mechanism 70 includes a conveyance belt 71 functioning as a movable surface, which constitutes a conveyance device for conveying the sheet S through the movement of the movable surface in contact with the sheet S.

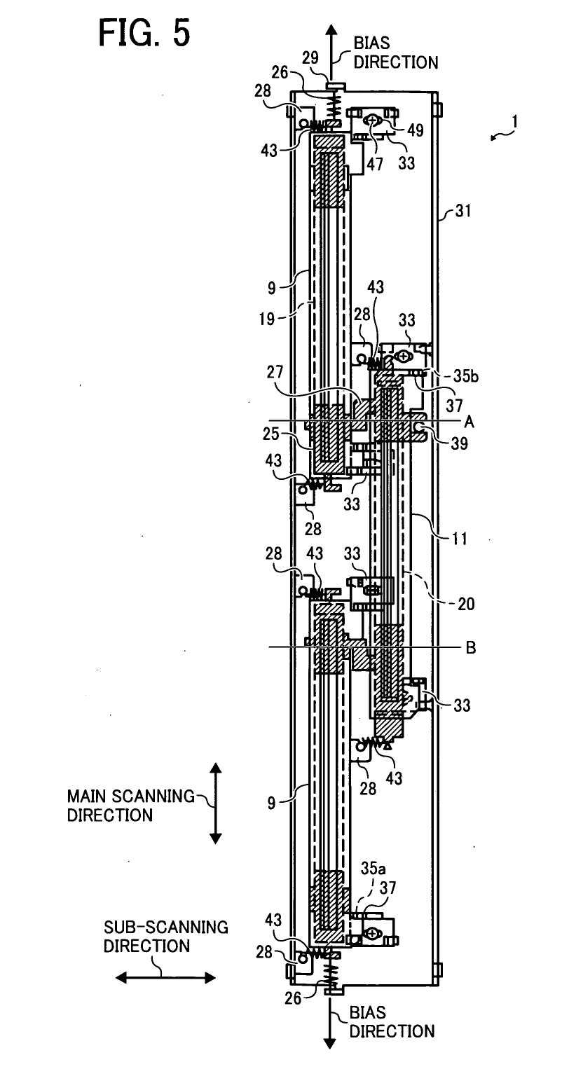

FIG. 5 is a top view of the two first image sensors 9 and the second image sensor 11, as viewed from the side of the contact glass 3. The image scanning device 1 according to the present embodiment includes the two first image sensors 9 for scanning image portions of the sheet S conveyed by the first conveyance rollers 5, and the second image sensor 1.1 for scanning the image portion other than the image portions scanned by the two first image sensors 9. The two first image sensors 9 are located upstream of the second image sensor 11 in a sheet conveyance direction, i.e., a sub scanning direction, and are disposed on the opposite sides of the contact glass 3 in a sheet width direction, i.e., a main scanning direction. Meanwhile, the second image sensor 11 is located downstream of the two first image sensors 9 in the sheet conveyance direction, and is disposed at the center of the contact glass 3 in the sheet width direction such that the scanning area of the second image sensor 11 overlaps with the scanning areas of the two first image sensors 9 in the sheet width direction. As described above, the three image sensors, i.e., the two first image sensors 9 and the second image sensor 11 are arranged in a zigzag pattern such that adjacent two of the three image sensors overlap with each other in the scanning area in the sheet width direction and are different from each other in the position in the sheet conveyance direction.

Each of the two first image sensors 9 and the second image sensor 11 includes therein an illumination lamp 15. The illumination lamp 15 radiates a predetermined amount of light to an image-formed surface of the sheet S. Reflected light reflected by the image-formed surface and corresponding to an image formed on the image-formed surface is formed into an image of the original size at a light-receiving element 21 on a sensor substrate 19 or a sensor substrate 20 via a cellfox lens 17, which is an imaging lens. The illumination lamp 15, the cellfox lens 17, the sensor substrate 19 or the sensor substrate 20, and so forth are held by a housing 23.

The two first image sensors 9 and the second image sensor 11 are provided in a box-shaped base portion 31. The sensor substrate 19 for each of the first image sensors 9 is provided with a first connection member 25, which is fixed to one end portion of the sensor substrate 19 and protrudes toward the second image sensor 11. Further, the sensor substrate 20 for the second image sensor 11 is provided with a second connection member 27, which is fixed to each of the opposite end portions of the sensor substrate 20 and protrudes toward the corresponding first image sensor 9.

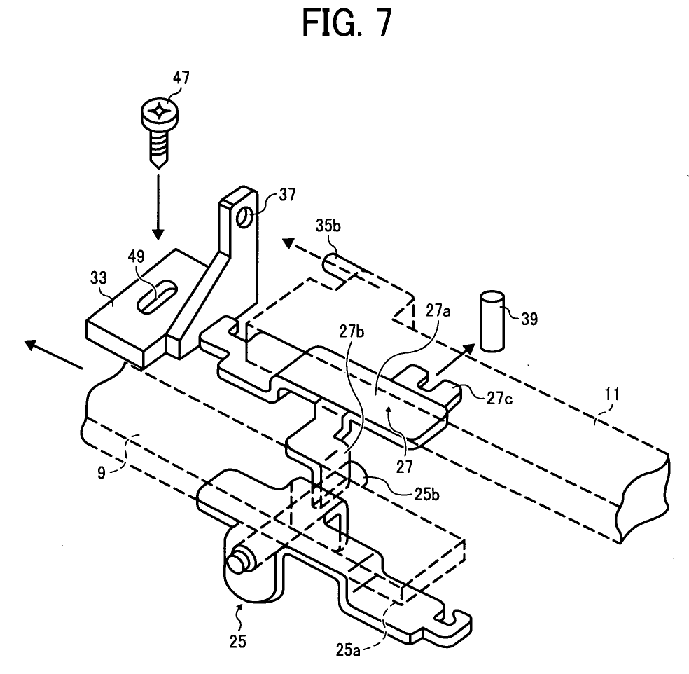

Herein, description will be made of a specific configuration of each of the first connection member 25 and the second connection member 27 on the basis of FIG. 7. In FIG. 7, the first connection member 25 includes a body portion 25a and a pin 25b which is a cylindrical member rotatably supported by the body portion 25a and protruding toward the second connection member 27. The first connection member 25 is formed of a metal lower in thermal expansion coefficient than the sensor substrate 19. Meanwhile, the second connection member 27 includes a body portion 27a, an L-shaped pressure-contact portion 27b protruding from the body portion 27a toward the first connection member 25 and pressure-contacted with the pin 25b, and an engaging piece 27c engageable with a positioning pin 39 provided upright on the base portion 31. The second connection member 27 is formed of a metal lower in thermal expansion coefficient than the sensor substrate 20. The position at which the pin 25b of the first connection member 25 and the pressure-contact portion 27b of the second connection member 27 are pressure-contacted with each other is set to the boundary position between the scanning area of the corresponding first image sensor 9 and the scanning area of the second image sensor 11, as indicated by lines A and B in FIG. 5. The pin 25b and the pressure-contact portion 27b are pressure-contacted with each other in the sheet width direction. In the plan view of FIG. 5, the first connection members 25 and the second connection members 27 are marked by hatching.

A first spring 26 functioning as a biasing device is provided between the other end portion of each of the sensor substrates 19 and a corresponding bracket 29 provided to the base portion 31. The first spring 26 outwardly biases the corresponding first image sensor 9 in the sheet width direction via the sensor substrate 19. Therefore, the first connection member 25 and the second connection member 27 are pressure-contacted with each other in the sheet width direction. Further, a second spring 43 functioning as a biasing device is provided between each of the opposite end portions of the sensor substrates 19 and the sensor substrate 20 and a corresponding bracket 28 formed to the base portion 31. The second springs 43 bias the first image sensors 9 and the second image sensor 11 in a direction of rotation around a rotation axis extending in the sheet width direction. The first springs 26 and the second springs 43 are fixed to the sensor substrates 19.

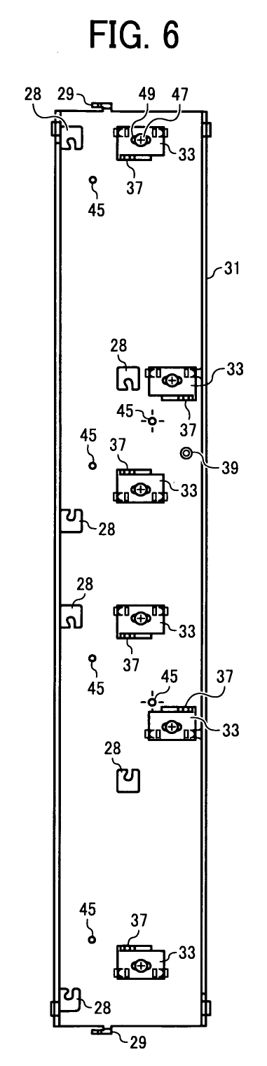

The base portion 31 is provided with adjustment screws 45 which are adjustment members, as illustrated in FIGS. 4 and 6. If the adjustment screws 45 are tightened and moved upward, the first image sensors 9 and the second image sensor 11 are pressed upward against the biasing force of the second springs 4.3. Meanwhile, if the adjustment screws 45 are loosened and moved downward, the first image sensors 9 and the second image sensor 11 are biased by the second springs 43 and rotated downward. Accordingly, the position of the sensors in the direction of rotation is determined.

The first image sensors 9 and the second image sensor 11 are supported by support portions 33 provided to the base portion 31. Specifically, the engaging piece 27c of the second connection member 27 is engaged with the positioning pin 39 provided upright on the base portion 31. Further, reference pins 35a provided to the opposite end portions of the first image sensors 9 and reference pins 35b provided to the opposite end portions of the second image sensor 11 are engaged with engaging holes 37 formed in the support portions 33. Accordingly, the movement of the first image sensors 9 and the second image sensor 11 is controlled in the sheet conveyance direction.

The movement of the first image sensors 9 and the second image sensor 11 in the sheet width direction is controlled by the positioning pin 39 provided upright on the base portion 31 when the positioning pin 39 hits against the engaging piece 27c provided to the second connection member 27 of the second image sensor 11.

Each of the support portions 33 is formed with a guide hole 49 at a bottom portion thereof. With a screw 47 screwed into the base portion 31 through the guide hole 49, the support portion 33 is fixed to the base portion 31. The guide hole 49 is formed to be long in the sheet conveyance direction so that the position of the support portion 33 can be adjusted in the sheet conveyance direction with respect to the base portion 31.

Herein, description will be made of a method of installing the first image sensors 9 and the second image sensor 11 to the base portion 31.

To install the first image sensors 9 and the second image sensor 11 to the base portion 31 in the state illustrated in FIG. 6, the reference pins 35b provided to the second image sensor 11 are engaged in the engaging holes 37 formed in the support portions 33. Further, the engaging piece 27 is engaged with the positioning pin 39 to position the second image sensor 11 on the base portion 31. Thereafter, the second springs 43 are attached to the brackets 28.

Then, the reference pins 35a provided to the first image sensors 9 are engaged in the engaging holes 37 formed in the support portions 33 to position the first image sensors 9 on the base portion 31. Thereafter, the second springs 43 are attached to the brackets 28, and the first springs are attached to the brackets 29.

In this case, the movement of the first image sensors 9 and the second image sensor 11 in the sheet width direction is controlled by the positioning pin 39.provided upright on the base portion 31 when the positioning pin 39 hits against the engaging piece 27c provided to the second connection member 27 of the second image sensor 11.

The first image sensors 9 are outwardly biased in the sheet width direction by the first springs 26. Therefore, the pin 25b of each of the first connection members 25 is pressure-contacted with the pressure-contact portion 27b of the corresponding second connection member 27. As a result, the first image sensors 9 and the second image sensor 11 are positioned in the sheet width direction.

Further, with the first image sensors 9 and the second image sensor 11 biased by the second springs 43, the first image sensors 9 and the second image sensor 11 are biased in the direction of rotation. In this case, the base portion 31 is provided with the adjustment screws 45. Therefore, if the adjustment screws 45 are tightened and moved upward, the first image sensors 9 and the second image sensor 11 are pressed upward against the biasing force of the second springs 43. Meanwhile, if the adjustment screws 45 are loosened and moved downward, the first image sensors 9 and the second image sensor 11 are biased by the second springs 43 and rotated downward. Accordingly, the position of the sensors in the direction of rotation is determined.

The bottom portion of each of the support portions 33 is formed with the guide hole 49 which is long in the sheet conveyance direction. Therefore, with the screw 47 moved along the guide hole 49,and tightened into the support portion 33, the positions of the first image sensors 9 and the second image sensor 11 in the sheet conveyance direction are determined.

As described above, in the present embodiment, the first connection members 25 and the second connection members 27 of the mutually facing first image sensors 9 and second image sensor 11 are biased by the first springs 26 and pressure-contacted with each other. Therefore, the first image sensors 9 and the second image sensor 11 can be integrated together via the first connection members 25 and second connection members 27.

Accordingly, even if the first image sensors 9 and the second image sensor 11 are thermally expanded due to a change in temperature environment, the first image sensors 9 and the second image sensor 11 are connected together at the boundary positions thereof via the first connection members 25 and second connection members 27. Therefore, the positional relationship between the first image sensors 9 and the second image sensor 11 is hardly changed. Accordingly, it is possible to prevent positional deviation in the first image sensors 9 and the second image sensor 11, and thus to prevent, for example, deviation or partial missing of image from occurring in the scanned images. As a result, the image quality can be improved.

The mutually facing first image sensors 9 and second image sensor 11 are connected together via the first connection members 25 and second connection members 27 biased by the first springs 26. Therefore, it is possible to prevent deviation in installation position of the first image sensors 9 and the second image sensor 11 due to external force from occurring between before and after the installation of the image sensors, unlike the background example in which the first image sensors 900 and the second image sensor 110 are fastened by bonding, screws, and so forth. Accordingly, it is possible to prevent, for example, the deviation or partial missing of image from occurring in the scanned images. As a result, the image quality can be improved.

The first connection members 25 and the second connection members 27 are pressure-contacted with each other by the first springs 26. Therefore, the configuration of the image scanning device 1 can be simplified, and the first image sensors 9 and the second image sensor 11 can be easily installed. Further, the focus adjustment can be performed in the sheet conveyance direction and with respect to the image-formed surface of the sheet S after the installation of the first image sensors 9 and the second image sensor 11 in the sheet width direction.

The first connection members 25 and the second connection members 27 of the present embodiment are integrally provided to the first image sensors 9 and the second image sensor 11. Therefore, the configuration of the first image sensors 9 and the second image sensor 11 can be simplified. Alternatively, the first connection members 25 and second connection members 27 may be provided separately from the first image sensors 9 and the second image sensor 11 and fixed to the first image sensors 9 and the second image sensor 11 by fixing devices such as screws. In such a configuration, the first connection members 25 and the second connection members 27 may be formed of a material lower in thermal expansion coefficient than the sensor substrates 19 for the first image sensors 9 and a material lower in thermal expansion coefficient than the sensor substrate 20 for the second image sensor 11, respectively. Thereby, even if the first image sensors 9 and the second image sensor 11 are thermally expanded due to a change in temperature environment, a change in the boundary positions between the first image sensors 9 and the second image sensor 11 can be suppressed. Accordingly, it is possible to further suppress the change in the positional relationship between the first image sensors 9 and the second image sensor 11.

In the present embodiment, the positions at which the first connection members 25 and the second connection members 27 are pressure-contacted with each other are set to the boundary positions between the scanning areas of the mutually facing first image sensors 9 and second image sensor 11. Therefore, even if there is a difference in thermal expansion coefficient between the first connection members 25 and the first image sensors 9 due to a difference in constituent material between the first connection members 25 and the first image sensors 9 (particularly,.the sensor substrates 19), or if there is a difference in thermal expansion coefficient between the second connection members 27 and the second image sensor 11 due to a difference in constituent material between the second connection members 27 and the second image sensor 11 (particularly, the sensor substrate 20), for example, it is possible to prevent the deviation in the boundary positions, and to suppress the change in the positional relationship between the first image sensors 9 and the second image sensor 11.

In the present embodiment, each of the first connection members 25 is provided with the pin.25b pressure-contacted with the pressure-contact portion 27b of the corresponding second connection member 27. Therefore, the first connection member 25 and the second connection member 27 can be more smoothly moved on the pressure-contact surfaces thereof than in a configuration in which the pressure-contact surfaces of the first connection member 25 and the second connection member 27 are in surface-contact with each other. Accordingly, the positions of the first image sensors 9 and the second image sensor 11 can be easily adjusted after the installation of the sensors.

The present embodiment includes the base portion 31 for holding the first image sensors 9 and the second image sensor 11, and the support portions 33 for connecting the base portion 31 with the first image sensors 9 and the second image sensor 11. Further, the support portions 33 support the first image sensors. 9 and the second image sensor 11 to be adjustable in position in the sheet width direction and the sheet conveyance direction. Therefore, even if the first image sensors 9 and the second image sensor 11 are expanded in the sheet width direction due to a change in temperature environment, the first image sensors 9 and the second image sensor 11 can move in accordance with the stretch thereof caused by the expansion. Accordingly, the deformation of the first image sensors 9 and the second image sensor 11 can be prevented.

The first image sensors 9 and the second image sensor 11 are supported to be adjustable in position also in the sheet conveyance direction. Therefore, the first image sensors 9 and the second image sensor 11 can be adjusted in position in the sheet conveyance direction even after the installation of the first image sensors 9 and the second image sensor 11 to the base portion 31.

The present embodiment includes the base portion 31, the second springs 43, and the adjustment screws 45. The base portion 31 supports the first image sensors 9 and the second image sensor 11 to be rotatable in the vertical direction. The second springs 43 are provided between the base portion 31 and the first image sensors 9 and the second image sensor 11 to bias the first image sensors 9 and the second image sensor 11 in the direction of the base portion 31, i.e., the direction of rotation. The adjustment screws 45 press and adjust the first image sensors 9 and the second image sensor 11 in the vertical direction against the biasing force of the second springs 43. Therefore, even after the installation of the first image sensors 9 and the second image sensor 11 to the base portion 31, it is possible to perform the focus adjustment by rotationally move the first image sensors 9 and the second image sensor 11 in the vertical direction through the adjustment of the adjustment screws 45.

Description will now be made of operations of the image scanning device 1 in the present embodiment.

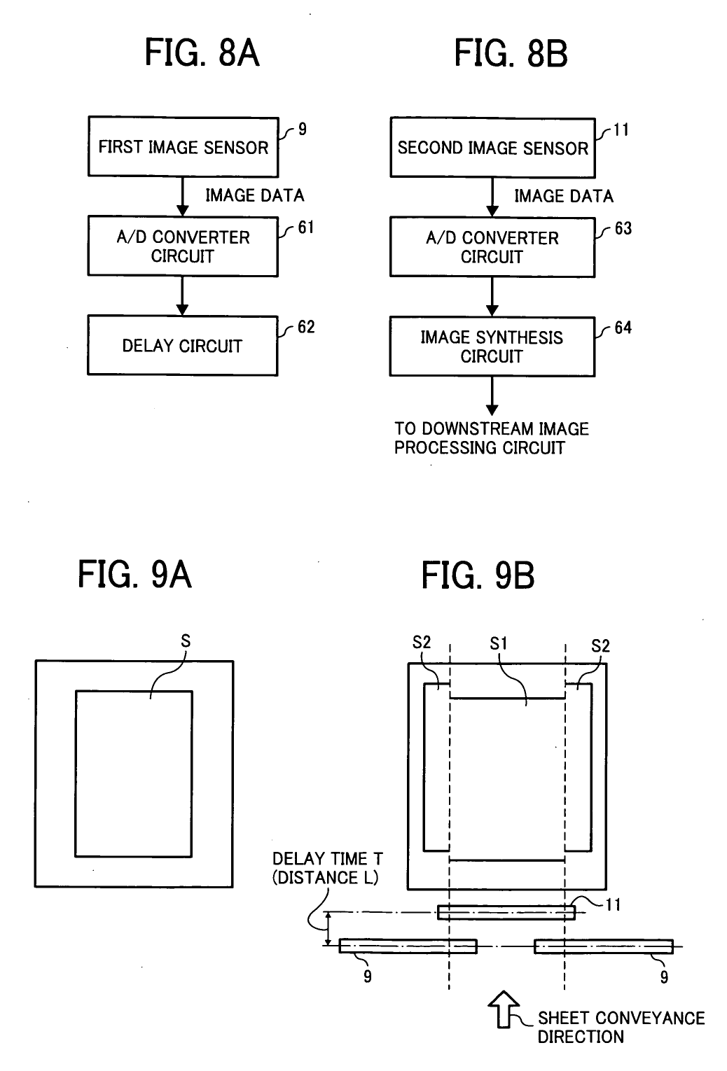

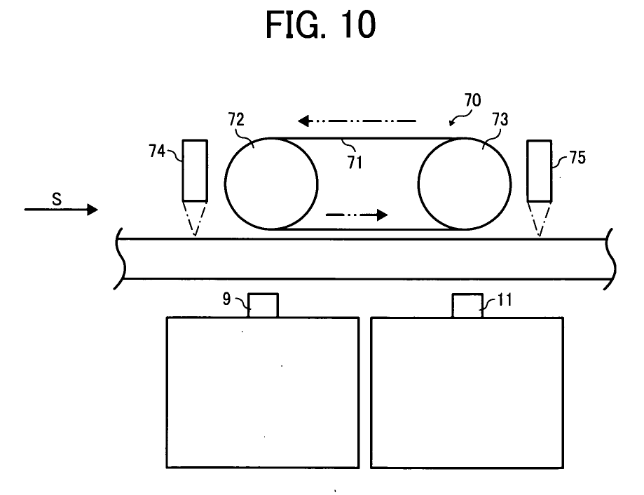

The sheet S inserted through the insertion opening for the sheet S is conveyed onto the contact glass 3 by the first conveyance rollers 5. In the process, as illustrated in FIGS. 9A and 9B, the first image sensors 9 first scan the opposite side portions S2 of the conveyed sheet S, and then the second image sensor 11 scans a central portion S1 of the conveyed sheet S. As illustrated in FIG. 8A, the image data of the sheet S scanned by the first image sensors 9 is converted from analog data into digital data by an A/D (Analog-to-Digital) converter circuit 61, and then is temporarily stored by a delay circuit 62 in a memory (not illustrated) for a predetermined time. Meanwhile, as illustrated in FIG. 8B, the image data of the sheet S scanned by the second image sensor 11 is converted from analog data into digital data by an A/D converter circuit 63, synthesized with the image data obtained from the scanning by the first image sensors 9, which has been temporarily stored in the above-described memory, by an image synthesis circuit 64, and transmitted to an image processing circuit (not illustrated) to be subjected to processing by the image processing circuit. As a result, image data sets aligned in the sheet width direction can be obtained.

Description will now be made of a configuration and operations of the belt conveyance mechanism 70, which constitutes a characteristic feature of the present invention.

FIG. 10 is an explanatory diagram illustrating a configuration of the surroundings of the belt conveyance mechanism 70 in the present embodiment.

The belt conveyance mechanism 70 includes a loop-shaped conveyance belt 71, a drive roller 72 functioning as a drive rotor, a driven roller 73 functioning as a driven rotor, a first sheet detection sensor 74 functioning as a detection device, and a second sheet detection sensor 75 functioning as a detection device.

The conveyance belt 71 is stretched over two supporting rotors, i.e., the drive roller 72 and the driven roller 73. A surface layer of the drive roller 72 is formed of a material having a relatively high friction coefficient, such as a rubber having a relatively low hardness and a relatively hard sponge. Either one or both of the two supporting rotors may be used as a drive rotor. The driving for the conveyance of the conveyance belt 71 by the drive roller 72 and the driving by the first conveyance rollers 5 and the second conveyance rollers 7 are independent from each other. However, the drive roller 72, the first conveyance rollers 5, and the second conveyance rollers 7 are set to have an equal conveyance speed, and are synchronized with one other in the scanning process. The belt conveyance mechanism 70 of the present embodiment includes the single conveyance belt 71 in the sheet conveyance direction. Alternatively, the belt conveyance mechanism 70 may include two or more conveyance belts in the sheet conveyance direction. In such a case, the two or more conveyance belts are provided in the sheet conveyance direction at positions at which the conveyance belts face the first image sensors 9 and the second image sensor 11, respectively. Still alternatively, a plurality of conveyance belts may be provided in the sheet width direction.

The conveyance belt 71 is formed of an electrically conductive rubber material. Further, the color of the conveyance belt 71 is white. Herein, the term white does not refer to the white color in the strict sense. That is, the term white refers to that the conveyance belt 71 is configured to have a surface having a predetermined level of reflectivity or higher (e.g., ninety percent or higher) in a substantially entire range of visible light.

The first sheet detection sensor 74 and the second sheet detection sensor 75 are provided on the upstream side and the downstream side of the belt conveyance mechanism 70 in the sheet conveyance direction, respectively. Upon detection by the first sheet detection sensor 74 of a leading end of the sheet S conveyed by the first conveyance rollers 5, the driving of the belt conveyance mechanism 70 is started. Then, the first image sensors 9 and the second image sensor 11 scan the image-formed surface of the sheet S passing over the upper surface of the contact glass 3 to obtain the image information from the image-formed surface. Then, upon detection by the second sheet detection sensor 75 of a rear end of the sheet S subjected to the scanning process, the driving of the belt conveyance mechanism 70 is stopped. Due to the above-described configuration, the driving time of the belt conveyance mechanism 70 is kept to a minimum necessary time in which the sheet S passes over the contact glass 3. Accordingly, it is possible to minimize troubles such as damage on the upper surface of the contact glass 3 due to scratching thereon by the conveyance belt 71 of the belt conveyance mechanism 70.

The clearance formed between the contact glass 3 and the conveyance belt 71 is set within a range of from approximately 0.1 millimeters to approximately 0.3 millimeters. Therefore, if the sheet S is free from a fold or a curl, the pressing force by the conveyance belt 71 does not act on the contact glass 3. Accordingly, the sheet S can be smoothly conveyed. Meanwhile, if the sheet S has a fold or a curl, the pressing force by the conveyance belt 71 acts on the contact glass 3 when the folded or curled portion of the sheet S passes through the clearance. Accordingly, a favorable scanning operation can be carried out.

As described above, the image scanning device 1 included in the copier according to the present embodiment includes the first conveyance rollers 5, the second conveyance rollers 7, the belt conveyance mechanism 70, and the plurality of image sensors, i.e., the first image sensors 9 and the second image sensor 11. The first conveyance rollers 5, the second conveyance rollers 7, and the belt conveyance mechanism 70 constitute a conveyance device for conveying the sheet S, i.e., the image scanning target such that the sheet S passes over a predetermined image scanning position, i.e., the upper surface of the contact glass 3. The first image sensors 9 and the second image sensor 11 are arranged at the positions facing the contact glass 3 and along the direction perpendicular to the sheet conveyance direction of the sheet S., i.e., the sheet width direction. With this configuration, the image scanning device 1 scans the sheet S passing over the upper surface of the contact glass 3 through the first image sensors 9 and the second image sensor 11 to obtain the image information of the sheet S. In the image scanning device 1, the first image sensors 9 and the second image sensor 11 are arranged in the zigzag pattern such that adjacent two of the first image sensors 9 and the second image sensor 11 overlap with each other in the scanning area in the sheet width direction and are different from each other in the position in the sheet conveyance direction. Further, the belt conveyance mechanism 70 includes the conveyance belt 71, which is provided at the position facing the first image sensors 9 and the second image sensor 11 across the contact glass 3, and which is the movable surface that moves to convey the sheet S in contact therewith. Due to the above-described configuration, the frictional resistance exerted on the sheet S passing over the upper surface of the contact glass 3 can be reduced more than in the background configuration in which the retainer plate 13 presses and holds the sheet S passing over the upper surface of the contact glass 3. It is therefore possible to reduce the difference in the frictional resistance which can be generated in the sheet S in the sheet width direction. Accordingly, it is possible to suppress the deviation in the sheet conveyance direction from occurring between the image information sets obtained from the scanning by the first image sensors 9 and the second image sensor 11.

As the movable surface, which may be a roller-type member, the present embodiment employs the conveyance belt 71 constituted by a loop-shaped belt stretched over the plurality of supporting rotors including the drive roller 72 functioning as the drive rotor and the driven roller 73. Accordingly, the single conveyance belt 71 can cover the entire area facing the first image sensors 9 and the second image sensor 11, which are disposed at the different positions in the sheet conveyance direction.

In the present embodiment, the plurality of supporting rotors, i.e., the drive roller 72 and the driven roller 73 over which the conveyance belt 71 is stretched are disposed at the positions facing the first image sensors 9 and the second image sensor 11, respectively. Accordingly, the sheet S can be firmly held in the respective scanning areas of the first image sensors 9 and the second image sensor 11.

In the present embodiment, each of the drive roller 72 and the driven roller 73 has the surface layer formed of a sponge material, for example. It is therefore possible to absorb an impact caused when a fold or the like of the sheet S enters into the clearance formed between the roller and the contact glass 3. Accordingly, it is possible to prevent a scan failure attributed to the impact caused when the fold or the like of the sheet S enters into the clearance.

In the present embodiment, the length in the sheet conveyance direction of the conveyance belt 71 is set to be shorter than the length in the sheet conveyance direction of the base portion 31, which is a sensor housing for supporting the first image sensors 9 and the second image sensor 11. Accordingly, it is possible to reduce the costs of the conveyance belt 71, and to improve the assembling and maintenance efficiencies of the conveyance belt 71.

In the present embodiment, the color of the surface of the conveyance belt 71 is white. Thus, the white correction can be performed. Further, the conveyance belt 71 is driven during the white correction. Therefore, there is a relatively low possibility that a scratch or dust on the conveyance belt 71 is scanned at the same position, and thus an effect against a white or black streak is obtained.

The present embodiment includes the first sheet detection sensor 74 and a control unit (not illustrated). The first sheet detection sensor 74 functions as the detection device for detecting the sheet S conveyed to the upper surface of the contact glass 3 before the sheet S passes through the upper surface. The control unit functions as a driving control device for controlling the driving of the conveyance belt 71, on the basis of the result of the detection by the first sheet detection sensor 74, such that the driving is started before the sheet S enters into the clearance above the upper surface of the contact glass 3, and that the driving is stopped immediately after the sheet S passes over the upper surface of the contact glass 3. Due to the above-described configuration, the driving time of the belt conveyance mechanism 70 is kept to the minimum necessary time in which the sheet S passes over the contact glass 3. Accordingly, it is possible to minimize troubles such as damage on the upper surface of the contact glass 3 due to scratching thereon by the conveyance belt 71 of the belt conveyance mechanism 70.

In the present embodiment, the conveyance belt 71 is formed of the electrically conductive material. Therefore, the conveyance belt 71 is less likely to be charged. Accordingly, a conveyance failure and so forth due to static electricity can be suppressed.

In the present embodiment, the clearance formed between the contact glass 3 and the conveyance belt 71 is set within the range of from approximately 0.1 millimeters to approximately 0.3 millimeters. With this configuration, the frictional resistance generated between the sheet S and the upper surface of the contact glass 3 is reduced in the conveyance of the sheet S, and the conveyance performance is improved more than in a configuration not provided with the clearance. Further, the above-described configuration has the effect of suppressing damage on the upper surface of the contact glass 3.

In the present embodiment, the image scanning is performed separately on the opposite side portions and the central portion of the sheet S by the first image sensors 9 and the second image sensor 11, respectively, which are arranged in the zigzag pattern. However, the embodiment is not limited thereto. Thus, the image scanning device 1 may be modified such that the first image sensors 9 and the second image sensor 11 are arranged obliquely with respect to a scanning surface to simultaneously scan the central portion and the opposite side portions of the sheet S.

The above-described embodiments are illustrative and do not limit the present invention. Thus, numerous additional modifications and variations are possible in light of the above teachings. For example, elements at least one of features of different illustrative and exemplary embodiments herein may be combined with each other at least one of substituted for each other within the scope of this disclosure and appended claims. Further, features of components of the embodiments, such as the number, the position, and the shape, are not limited the embodiments and thus may be preferably set. It is therefore to be understood that within the scope of the appended claims, the disclosure of this patent specification may be practiced otherwise than as specifically described herein.

1. An image forming apparatus comprising:
an image forming device for forming an image on a recording medium on the basis of image information of an image scanning target; and
an image scanning device for scanning the image scanning target to obtain the image information, the image scanning device including:
a conveyance device including a movable surface that conveys the image scanning target in contact therewith through a predetermined image scanning position; and
a plurality of image sensors arranged along a direction perpendicular to a conveyance direction of the image scanning target at positions facing the predetermined image scanning position and facing the conveyance device across the predetermined image scanning position to scan the image scanning target passing through the predetermined image scanning position and obtain the image information,
any adjacent two image sensors of the plurality of image sensors having mutually overlapping scanning areas in the perpendicular direction.

2. The image forming apparatus as described in claim 1, further comprising a plurality of supporting rotors including a drive rotor,
wherein the movable surface is a loop-shaped continuous belt stretched over the plurality of supporting rotors.

3. The image forming apparatus as described in claim 2,
wherein the plurality of supporting rotors is disposed at positions at least partially facing the plurality of image sensors.

4. The image forming apparatus as described in claim 2,
wherein each supporting rotor of the plurality of supporting rotors has a surface layer formed of a sponge material.

5. The image forming apparatus as described in claim 1, further comprising a sensor housing which supports the plurality of image sensors,
wherein the movable surface has a length in the conveyance direction of that is shorter than the length in the conveyance direction of the sensor housing.

6. The image forming apparatus as described in claim 1,
wherein the movable surface of the conveyance device of the scanning device is white.

7. The image forming apparatus as described in claim 1,
wherein the image scanning device further includes:
a detection device for detecting the image scanning target before the image scanning target conveyed to the predetermined image scanning position passes through the predetermined image scanning position; and
a driving control device for controlling driving of the movable surface on the basis of detection results provided by the detection device,
the driving control device starting driving of the movable surface before the image scanning target enters the predetermined image scanning position and stopping driving immediately after the image scanning target passes through the predetermined image scanning position.

8. The image forming apparatus as described in claim 1,
wherein the movable surface of the conveyance device of the scanning device is formed of an electrically conductive material.

9. The image forming apparatus as described in claim 1,
wherein the predetermined image scanning position and the plurality of image sensors are separated from each other by a transparent member, and
wherein a clearance in a range of from approximately 0.1 millimeters to approximately 0.3 millimeters is formed between the transparent member and the movable surface.

10. An image forming apparatus comprising:
image forming means for forming an image on a recording medium on the basis of image information of an image scanning target; and
image scanning means for scanning the image scanning target to obtain the image information, the image scanning means including:
conveyance means including a movable surface which moves to convey the image scanning target in contact therewith to have the image scanning target pass through a predetermined image scanning position, and
a plurality of image sensing means arranged along a perpendicular direction to a conveyance direction of the image scanning target at positions facing the predetermined image scanning position and facing the conveyance means across the predetermined image scanning position to scan the image scanning target passing through the predetermined image scanning position and obtain the image information,
any adjacent two image sensing means of the plurality of image sensing means having mutually overlapping scanning areas in the perpendicular direction.

11. An image scanning device comprising:
a conveyance device including a movable surface which conveys an image scanning target in contact therewith through a predetermined image scanning position; and
a plurality of image sensors arranged in a perpendicular direction to a conveyance direction of the image scanning target at positions facing the predetermined image scanning position and facing the conveyance device across the predetermined image scanning position to scan the image scanning target passing through the predetermined image scanning position and obtain the image information,
any adjacent two image sensors of the plurality of image sensors having mutually overlapping scanning areas in the perpendicular direction.

12. The image scanning device as described in claim 11, further comprising a plurality of supporting rotors including a drive rotor,
wherein the movable surface of the conveyance device is a loop-shaped continuous belt stretched over the plurality of supporting rotors.

13. The image scanning device as described in claim 12,
wherein the plurality of supporting rotors are disposed at positions at least partially facing the plurality of image sensors.

14. The image scanning device as described in claim 12,
wherein each of the plurality of supporting rotors has a surface layer formed of a sponge material.

15. The image scanning device as described in claim 11, further comprising a sensor housing which supports the plurality of image sensors,
wherein the movable surface has a length in the conveyance direction that is shorter than the length in the conveyance direction of the sensor housing.

16. The image scanning device as described in claim 11,
wherein the movable surface is white.

17. The image scanning device as described in claim 11, further comprising:
a detection device for detecting the image scanning target before the image scanning target conveyed to the predetermined image scanning position passes through the predetermined image scanning position; and
a driving control device for controlling driving of the movable surface on the basis of detection results provided by the detection device,
the starting the driving of the movable surface before the image scanning target enters the predetermined image scanning position and stopping the driving of the movable surface immediately after the image scanning target passes through the predetermined image scanning position.

18. The image scanning device as described in claim 11,
wherein the movable surface is formed of an electrically conductive material.

19. The image scanning device as described in claim 11,
wherein the predetermined image scanning position and the plurality of image sensors are separated from each other by a transparent member, and
wherein a clearance in a range of from approximately 0.1 millimeters to approximately 0.3 millimeters is formed between the transparent member and the movable surface.
